(19) United States
(12) Patent Application Publication
(10) Pub. No.: US 2022/0415061 A1
(43) Pub. Date: Dec. 29, 2022

(54) Device and System for Image Capture and Mapping of a Trailer

(71) Applicant: ZEBRA TECHNOLOGIES CORPORATION, Lincolnshire, IL (US)

(72) Inventors: James J. O'Hagan, McHenry, IL (US); Jay J. Williams, Glenview, IL (US)

(21) Appl. No.: 17/899,731

(22) Filed: Aug. 31, 2022

Related U.S. Application Data
(63) Continuation-in-part of application No. 13/919,030, filed on Jun. 17, 2013.

(51) Int. Cl. G06V 20/59; G06K 7/14

(52) U.S. Cl. CPC G06V 20/59; G06K 7/1408

(57) ABSTRACT

A device and system for image capture and mapping of a trailer are provided. The device and system facilitate image capture of an interior of the trailer by a monitor. The device comprises a reflective surface configured to reflect light between the trailer interior and monitor to modify a field of view (FOV) of the monitor and a label affixed to the reflective surface. The label comprises a non-reflecting indicia indicative of a position of the label in the trailer interior and the monitor has a FOV comprising the reflective surface and label. The system comprises a monitor configured to capture at least one image of the trailer interior, the reflective surface, and at least one label comprising an indicia indicative of a position of the at least one label in the trailer interior. The monitor has a FOV comprising at least one of the reflective surface and the at least one label.

### CROSS-REFERENCE TO RELATED APPLICATION

This application is a continuation-in-part of U.S. patent application Ser. No. 13/919,030, filed on Jun. 17, 2013, and incorporated herein by reference in its entirety.

### BACKGROUND

A crucial aspect for Transportation & Logistics enterprises is the efficient loading of individual packages on trailers at distribution facilities. It is desired that the loading be done quickly, safely and with as little wasted trailer space as possible. At present, an average utilization of 70% of trailer space is typical, leaving significant room for improvement.

Current solutions to determine loading efficiency may only provide a measure of trailer space utilization at the end of the loading process. For example, prior art package routing and trailer loading systems provide a means for identifying which packages have been loaded into which trailer and aggregating characteristics of the packages within a trailer (e.g. total volume and weight). Such systems provide a means of tracking trailer load performance (overall fullness of the trailer and space utilization efficiency), but only at the completion of a load, when real-time corrective action or feedback is not possible.

Such solutions cannot be used for purposes of improving utilization while the trailer is being loaded. In particular, these solutions do not provide a precise measurement of an interior space of a trailer or provide volume or depth information as the trailer is loaded. In addition, such solutions do not account for loading different trailer sections, nor do they provide any means of visualizing the utilization profile for a trailer or means for sending alerts based on utilization goals.

Accordingly, there is a need for a technique to determine a real-time and precise measurement of an interior space of a trailer and to determine utilization during a trailer loading procedure based on the measurement so that the utilization can be tracked and improved in real-time.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified perspective view of a system, in accordance with some embodiments of the present invention.

FIG. 2 is a simplified perspective view of the system of FIG. 1 during loading of the trailer.

FIG. 3 is a simplified rear view of FIG. 2.

FIG. 4 is a graphical representation displaying utilization measurements during loading of the trailer, in accordance with some embodiments of the present invention.

FIG. 5 is a graphical representation displaying estimated loading volumes for invisible sections of the trailer, in accordance with some embodiments of the present invention.

FIG. 6 is a graphical representation displaying trailer utilization measurement, in accordance with another embodiment of the present invention.

FIG. 7 is a simplified flow chart of a method, in accordance with some embodiments of the present invention.

FIG. 8 is a simplified perspective view of a system, in accordance with some embodiments of the present invention.

FIG. 9 illustrates labels of the system of FIG. 8, in accordance with some embodiments of the present invention.

FIGS. 10A and 10B illustrate example mirrors of the system of FIG. 8, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Efficiently loading packages into a transport container (e.g., a trailer) can maximize workforce productivity and minimize costs in the Transportation and Logistics industry. Known solutions provide metrics associated with overall fullness and space utilization efficiency but may not provide accurate real-time loading analytics based on a precise measurement of an interior space of a trailer.

By way of background, a trailer calibration or loading process can be executed by one or more individuals (e.g., a loader, a dockworker, a supervisor, etc.), a robot (e.g., an autonomous mobile robot (AMR)) and/or specialized equipment (e.g., a conveyor belt) in conjunction with one or more tools (e.g. broom, light, cart, etc.).

For example, a trailer calibration process can include one or more loaders executing similar or distinct tasks. For instance, during a trailer calibration time period, a first loader can utilize a broom to sweep the trailer, a second loader can position and/or configure equipment (e.g., a light, mirror, radio frequency (RF) beacon, etc.) within the trailer, and a third loader can affix one or more labels (e.g., an augmented label) to a floor, wall and/or ceiling of the trailer and determine the positions of the one or more labels utilizing a mobile imaging device. These loaders can execute their respective tasks (e.g., cleaning, equipping and/or configuration, and labelling) sequentially, concurrently or during partially overlapping time periods. It should be understood that a single loader can execute the required tasks.

In another example, during a trailer loading time period, a first loader can select packages and transport the packages proximate to an entrance of the trailer and a second loader can load the packages into the trailer by positioning the packages therein. A third loader or supervisor can monitor the trailer loading process to provide feedback or assistance. These loaders can execute their respective tasks (e.g., staging, packing and supervising) sequentially, concurrently or during partially overlapping time periods. It should be understood that the staging task can be executed by an individual, an AMR or a conveyor belt and that a loader can switch between executing the staging, packing and supervising tasks during the trailer loading time period. In addition, the trailer loading process can include one or more supervisors to monitor the trailer during different time periods (e.g., beginning, middle, and end) of the trailer loading time period.

An apparatus and method are described that provides a technique to determine utilization during a trailer loading procedure so that the utilization can be tracked, reported, and improved in real-time. The present invention integrates routing information with volumetric measurements of the trailers to give trailer loaders and supervisors visibility into load efficiency in real-time while the trailer is being loaded so actual loader performance can be compared to goals and corrective action taken to improve efficiency before the completion of the load.

A device and system are described herein that provide for image capture and mapping of a trailer. Examples described herein are directed to a device and system that facilitate image capture of an interior of the trailer by a monitor. The device comprises a reflective surface configured to reflect light between the trailer interior and monitor to modify a field of view of the monitor and a label affixed to the reflective surface. The label comprises a non-reflecting indicia indicative of a position of the label in the trailer interior and the monitor has a field of view comprising the reflective surface and label. The system comprises a monitor configured to capture at least one image of the trailer interior, the reflective surface, and at least one label comprising an indicia indicative of a position of the at least one label in the trailer interior. The monitor has a field of view comprising at least one of the reflective surface and the at least one label. In another example, the system maps a trailer and comprises a mobile imaging device, a mirror, a monitor, and a processor. The mobile imaging device is operable to capture a first plurality of images of an interior of the trailer where the first plurality of images is indicative of a visible section of the trailer and a hidden section of the trailer. The monitor is also operable to determine, based on the first plurality of images, a position for at least one label in the hidden section of the trailer, and alert, based on the determination, a user to affix the at least one label to the determined position. The mirror is positioned within the interior of the trailer and the monitor is operable to capture a second plurality of images. The second plurality of images is indicative of a mirror reflection of the hidden section provided by the mirror. The processor is coupled to the mobile imaging device and the monitor and is operable to generate a map of the interior of the trailer using at least one of first image information associated with the first plurality of images and second image information associated with the second plurality of images.

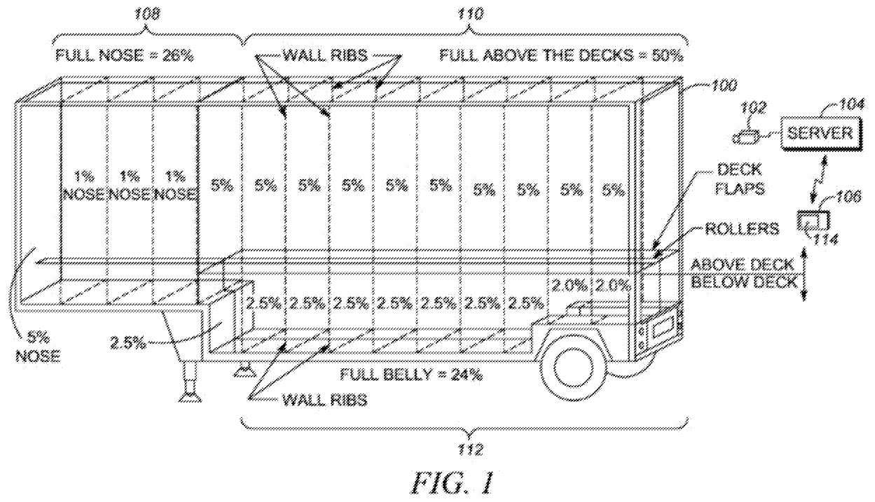

FIG. 1 is a simplified perspective view of a system, in accordance with some embodiments of the present invention. The present invention includes a monitor 102 to image the loading of the trailer. The monitor may comprise a video camera device, such as a RGB camera, as is known in the art, and any type of three dimensional depth/volume monitor, such as a stereo, structured light or time-of-flight depth camera, an infrared three dimensional depth/volume camera, and the like able to determine a distance to the points (i.e. pixels) in an image.

The monitor 102 is coupled to a server or processor 104 and is operable to transfer imaging information about trailer loading to the processor. The monitor may transfer the imaging information to the processor using wired (shown) or wireless (not shown) communication, such as a wireless local area network for example. The processor 104 can also provide wireless (shown) or wired (not shown) communication with mobile terminals 106 within the network for purposes of conveying information via a user interface 114 of the terminal or providing instructions to a loader using the terminal about how that person is loading the trailer. The user interface can provide an audible alert or a distinct vibration pattern for a worn device, or the user interface can be a graphical display or textual device. The protocols and messaging needed to establish wireless communications are known in the art and will not be presented here for the sake of brevity.

The processor 104 can determine trailer utilization in real-time during loading of the trailer using image information from the monitor 102 and existing package scanning equipment. The processor can process this image information to determine utilization of the trailer loading and send this utilization information to the graphical user interface 114 of the mobile terminal 106 to display a visual representation of real-time loading of the trailer. The visual representation can be provided on a terminal which can comprise a mobile device, a leaderboard or dashboard, a service kiosk, or a device that is wearable by a loader such as a heads up display (HUD) or smartwatch.

Various entities adapted to support the inventive concepts of the embodiments of the present invention. Those skilled in the art will recognize that the figures do not depict all of the equipment necessary for network to operate but only those components and logical entities particularly relevant to the description of embodiments herein. For example, servers, imaging devices, and communication terminals can all includes separate processors, communication interfaces, transceivers, memories, displays, optical devices, etc. In general, components such as processors, communication devices, displays, and optical devices are well-known. For example, processing units are known to comprise basic components such as, but not limited to, microprocessors, microcontrollers, digital signal processors, memory cache, application-specific integrated circuits, and/or logic circuitry. Such components are typically adapted to implement algorithms and/or protocols that have been expressed using high-level design languages or descriptions, expressed using computer instructions, or expressed using messaging logic flow diagrams.

Thus, given an algorithm, a logic flow, and/or a messaging/signaling flow, those skilled in the art are aware of the many design and development techniques available to implement a processor that performs the given logic. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the image processing and control aspects of the present invention may be implemented in any of the devices listed above or distributed across such components. It is within the contemplation of the invention that the operating requirements of the present invention can be implemented in software in conjunction with firmware or hardware.

Specifically, the system described herein combines package loading information with a trailer load monitor to compute a real-time measurement of trailer utilization, i.e. how well the trailer is loaded. The system can also accommodate trailers with multiple sections (such as shown in FIG. 1), some of which may not be directly sensed by the monitor. The present invention works whether the trailer monitor provides depth or volume information. The monitor can be stationary or mobile, as long as the image measurements can be referenced to the trailer coordinate system.

The present invention maintains a model of the state of the packages and the trailer. This includes maintaining a package model, which describes a correlation between the unique package ID that is obtained (e.g. scanned) before the package is loaded and the packages' attributes such as length, width and height (or equivalently volume), and weight. The present invention also maintains a trailer dimension model, which describes a trailer type, its dimensions, and utilization goals, i.e. how well that trailer should be loaded. Trailers may have multiple sections as shown in FIG. 1 (i.e. four sections in this case, left and right belly sections 112, a nose section 108, and a main section 110). The utilization goals may be different in each section. The goals may also be different for different trailer models, loading facilities, teams, or individual loaders.

During sorting and before loading, each package is passed through a dimensioning scan, which scans each package to determine package dimensions (and possibly weight, condition, or other attributes), whereupon the system updates the package model. Upon loading, each package passes through a loading scan, where the system correlates the package with its volume from the dimensions of the package model to determine the cumulative package volume, V_{packages}, within the trailer. The system also correlates the package load time with the filled trailer space, V_{loaded}, at that time. The system calculates the instantaneous trailer utilization, U, as the ratio of cumulative package volume to currently loaded volume, U=V_{packages}/V_{loaded}.

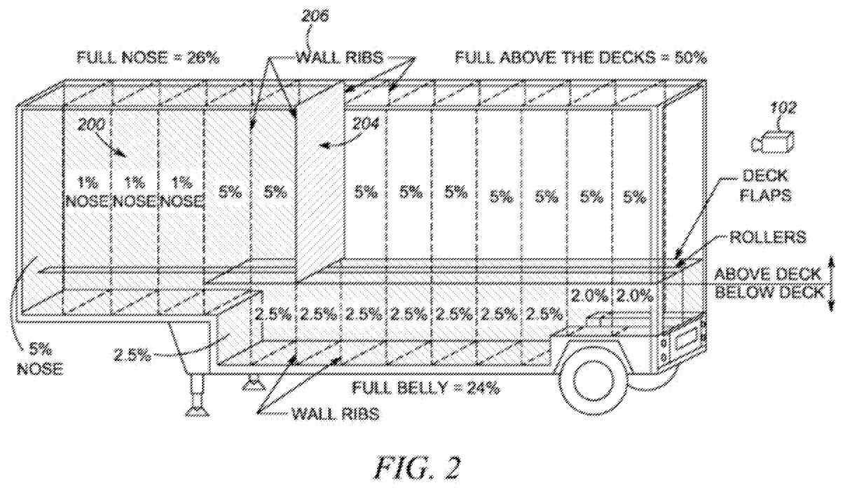

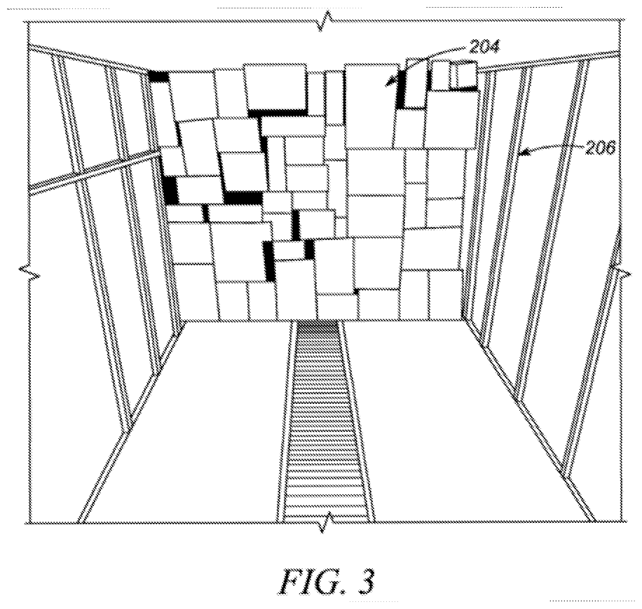

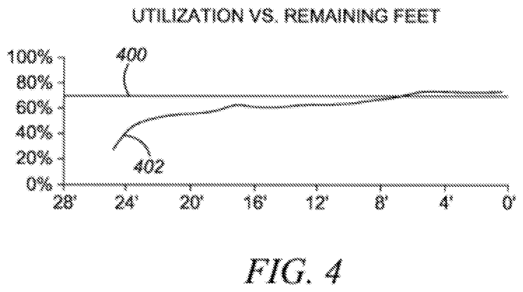

The system generates a real-time visualization of the utilization for loaders and supervisors, an example is shown in FIG. 2. For example, the monitor is able to determine a depth to the latest filled “wall” 204 of the loading. This wall 204 is also show from a rear view in FIG. 3 as seen from the perspective of the monitor. Knowing the trailer dimensional model and the depth of the wall 204, the processor is able to determine the filled volume 200 of the trailer, V_{loaded}. Given the volume of the packages that were pre-scanned for their dimensions, and having been scanned as loaded gives the volume of packages, V_{packages}, that have already been loaded, whereupon the instantaneous trailer utilization, U=V_{packages}/V_{loaded}, can be determined, as represented in FIG. 4 where the instantaneous utilization 402 is plotted versus fullness of the trailer (i.e. the remaining feet to be filled. As can be seen, at point of 20′ from the back of the trailer, loaders can see early that they are behind goal and can adjust to improve utilization before the trailer is finished loading at 0′. Optionally, an alert can be generated for a system administrator or loader when the measured utilization 402 does not reach a target utilization 400.

The direct measurement of utilization above is for the case of a trailer where the monitor can view the entire contents, e.g. for a trailer having no hidden sections outside the field of view of the monitor. There are two ways to handle hidden sections, where portions of the trailer that are not observable by the monitor, based on the type of information reported by the trailer monitor. If the monitor reports a three dimensional volumetric representation such as a point cloud or geometric model, the individual loaded section volumes V_{loaded}^{s} can be computed by intersecting the three dimensional representation with the section volume from the trailer dimension model. As defined herein, a point cloud defines each “pixel” of an image having three-dimensional coordinates. For example, an RGB value from a camera image has an x,y,z location for each pixel. The “point cloud” is that collection of x,y,z location “pixels” detected by the monitor, allowing the recreation of the three-dimensional environment of the trailer.

The package section volumes V_{package}^{s} can be computed by correlating package scan times with loaded section volume changes. For example, as packages are dimensionally scanned before loading, these package must take up a certain volume when loaded in a section. In other words, the change in loaded section volumes

ΔV_{loaded}^{s}=V_{loaded}^{s}(t+Δt)−V_{loaded}^{s}(t)

allows us to compute the ratio of loaded volume change in each section

$${R}^{s} = Δ {V}_{loaded}^{s} / {\sum }_{s ∈ S} Δ {V}_{loaded}^{s}$$

and use those ratios to allocate packages loaded during that interval to likely sections.

ΔV_{package}^{s}=R^{s}(V_{package}(t+Δt)−V_{package}(t))

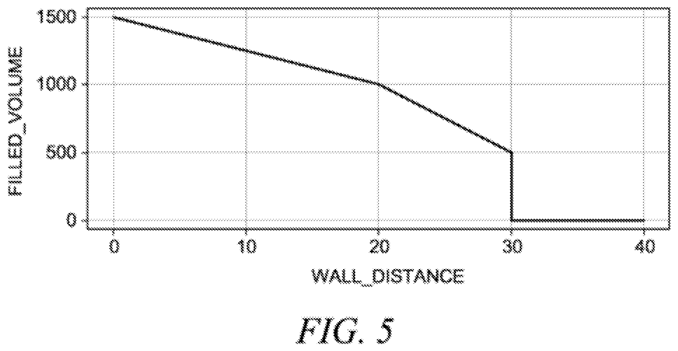

In the case that the trailer monitor reports a single depth measurement, instead of a volume measurement, the sections are divided linearly along the depth-sensing axis. Those sections that are not along the axis (such as the belly), or are beyond the range of the depth monitor, may be lumped into an “invisible” section. In this case, the loaded volumes are computed as in FIG. 5. Beyond the trailer end, or monitor range (e.g. 30 feet), the “invisible” volume is not counted. But once the wall depth changes within monitor range, the “invisible” areas are assumed to be full. For example, once the monitor starts “seeing” a wall of packages at 30 feet, it can be assumed that the 500 cu. ft. belly of the trailer has been filled. The different cross-sectional areas of different sections lead to different slopes in the volume profile. For example, the nose of the trailer has a different cross sectional area than the main section leading to a different slope of volume change with distance in the 20-30′ range.

The package section volumes V_{package}^{s} can be computed as the sum of the individual package volumes that are loaded between section transition times. For example, from FIG. 5, there is an invisible section (e.g. a belly section), a 10′ long nose section at the back of a 30′ trailer and a 20′ long main section. The package volume of the belly would be the volume of those packages scanned and loaded before the distance decreased below 30′. The package volume of the nose section would be the sum from the packages loaded between the wall distances of 30′ and 20′, and so on.

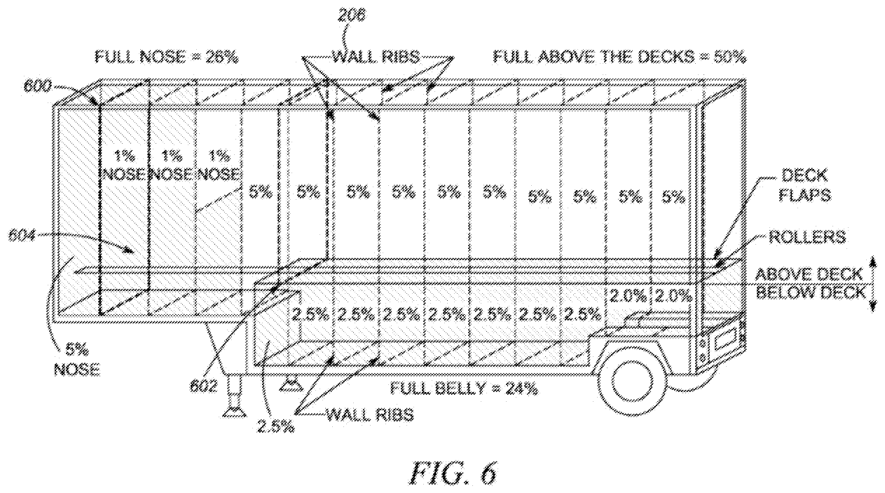

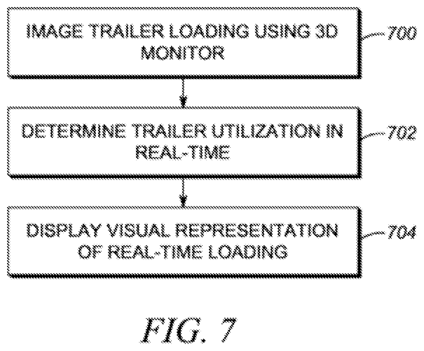

In the absence of depth information, the system can generate a graphical representation of the target trailer fullness given the actual package volume scanned and target utilization for each section as shown in FIG. 6. This is particularly useful for sections that are not completely visible by the trailer monitor. Without depth, the goal loaded volume (package volume/target utilization) can be displayed in a diagram on a user interface as shown. Loaders compare the shaded area 604 to the current wall location to know if they are ahead or behind goal. For example, a real wall of packages at position 600 means the loader is ahead of goal, where packages are using less space than the target utilization. However, having the wall of packages at position 602 means the loader is behind the goal. Ribs 206 and other visual landmarks within the trailer make this relatively an easy task to perform. For example, a loader can count the number of ribs from the wall of packages to the back of the trailer to determine where the loader is in the loading process, or a label with a human readable position indication may be affixed to the interior wall. FIG. 7 illustrates a flowchart of a method for real-time trailer utilization measurement, in accordance with the present invention. The method includes a first step 700 of imaging loading of a trailer using a three-dimensional monitor. The monitor can be a three-dimensional depth/volume camera operable to provide a fill distance to determine a loaded volume of the trailer. Optionally, the monitor includes a video camera operable to provide an optical image that is merged with the fill distance to provide an image of fill depth used by the processor to determine trailer utilization in the determining step.

A next step 702 includes determining trailer utilization in real-time during loading of the trailer using image information from the three-dimensional monitor and package information (e.g. volume from dimension scans) for packages loaded in the trailer. This can include establishing utilization as a ratio of cumulative package volume to currently loaded volume of the trailer, wherein the cumulative package volume is determined from dimensional scans of packages to be loaded in the trailer and the currently loaded volume is determined by the monitor. This step can also include estimating utilization for any portions of the trailer that are not observable by the monitor. In particular, a package section volume of a hidden section can be computed by correlating package scan times with changes in loaded section volume. Alternatively, a package section volume can be computed as the sum of the individual package volumes that are loaded between section transition times. This step can also include calculating a speed and/or rate at which the trailer is being loaded.

A next step 704 includes conveying or displaying, via a user interface, a representation of real-time loading of the trailer using received utilization information. Optionally, this step can include generating an alert when a determined utilization falls below a target threshold.

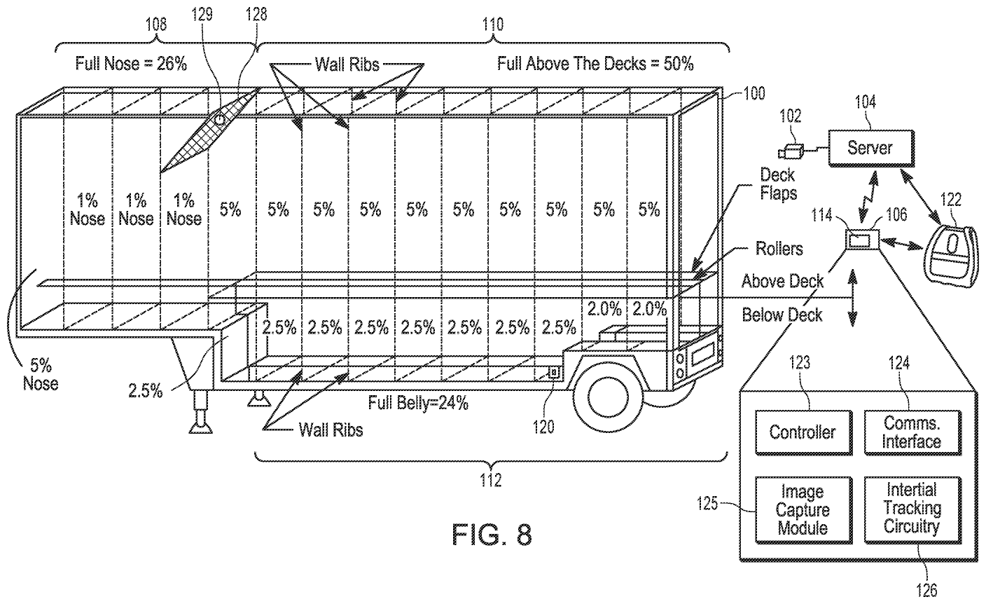

FIG. 8 is a simplified perspective view of a system in accordance with some embodiments of the present invention. As mentioned above, the present invention can include a monitor 102 to image the loading of the trailer. The monitor can comprise a camera device (e.g., a video camera or a RGB camera) and any type of three-dimensional (depth/volume monitor, such as a stereo, structured light or time-of-flight depth camera, and an infrared three-dimensional depth/volume camera, to determine a distance to points (e.g., pixels) in an image. The trailer can be positioned (e.g., parked) at a loading dock and the monitor 102 can be fixed in a position proximate to an entrance of the trailer. The monitor 102 can be oriented to capture at least one image from a field of view comprising an interior of the trailer and can capture a set of points having x, y, z coordinates such as a point cloud comprising a plurality of points.

The monitor 102 is coupled to a server or processor 104 and is operable to transfer imaging information about trailer calibration and/or loading to the processor 104. The monitor 102 can transfer the imaging information to the processor 104 using wired (shown) or wireless (not shown) communication, such as a wireless local area network for example.

As shown in FIG. 8, in an embodiment, the present invention can also include at least one augmented label 120, a mobile terminal 106 (e.g., a mobile imaging device), a mobile printing device 122 (e.g., a mobile printer) and a mirror 128 having an augmented mirror label 129.

The augmented label 120 can be applied to an interior of the trailer via an adhesive backing or any other suitable means. The monitor 102 can detect the augmented label 120 to facilitate image measurements referenced to a trailer coordinate system.

The augmented label 120 can include a flexible substrate (e.g., paper or polyester) with two opposing surfaces (e.g., a first surface and a second surface). The first surface can be coated with an adhesive and the second surface can be non-printable or printable. For example, the printable surface can be printed with a printed image utilizing any suitable printing apparatus and/or technique (e.g., a flexographic printing press and associated printing plate for marking flexographic ink onto a surface). The printable surface can be coated with a thermographic material. The thermographic material can be a first color or colorless until heated above a transition temperature (e.g., when exposed to heat from a thermal printer printhead) such that it changes to a second color. The printable surface can be configured to receive ink or dye from a thermal ribbon when exposed to heat from a thermal printer printhead. A protective material (e.g., a varnish or laminate) can be applied to the printable surface to protect the printed image thereon from damage. A liner (e.g., a silicone coated paper liner) can be affixed to the adhesive surface to facilitate handling while printing and/or prior to affixing the augmented label 120 to an interior of the trailer.

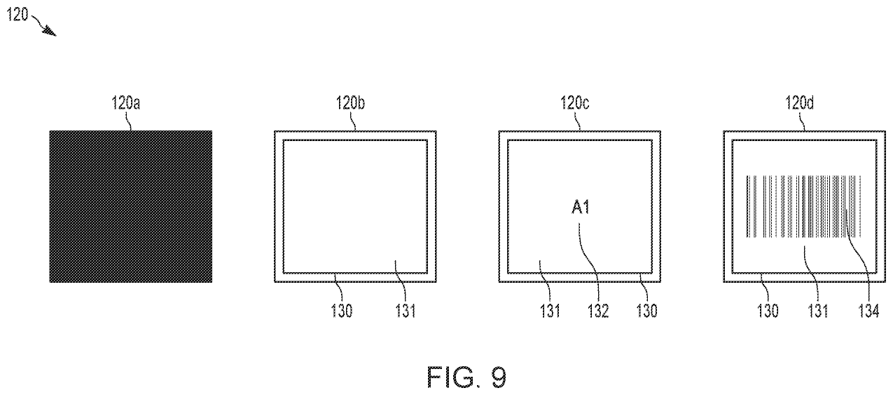

FIG. 9 illustrates labels 120a-d (collectively referred to as augmented labels 120) of the system of FIG. 8. The augmented label 120 can provide a contrasting image within an image captured by the monitor 102 such that the monitor 102 can utilize the augmented label 120 as a visible marker. The monitor 102 may detect a visual contrast of the augmented label 120 via wavelengths that are not visible to the human eye.

For example, an image captured by the monitor 102, including a white augmented label 120 affixed to a dark trailer wall, can display different light intensities because the white augmented label 120 can reflect more light than the dark trailer wall. In another example, an image captured by the monitor 102, including a black augmented label 120 affixed to a light trailer wall, can also display different light intensities because the black augmented label 120 can reflect less light than the light trailer wall. In yet another example, a retroreflective augmented label 120 affixed to a non-reflective trailer wall can also display different light intensities.

As shown in FIG. 9, the monitor 102 can utilize non-printed or printed augmented labels 120 having different characteristics (e.g., color, size, shape, etc.). For example, augmented label 120a is a non-printed label such that the augmented label 120a provides a contrasting marker visible to the monitor 102 via the non-printed surface thereof (e.g., black substrate) against a contrasting background (e.g., a trailer wall, ceiling and/or floor). The non-printed augmented label 120a can be any suitable color (e.g., black, white, yellow, etc.), size, and/or shape (e.g., square, circle, polygon, etc.).

Augmented labels 120b-d are printed labels having a printed image that provides a contrast with a printable surface of a substrate (e.g., a black printed image on a white substrate printable surface). For example, augmented label 120b is a printed label having a black square graphic 130 printed on a white substrate surface 131 such that the black square graphic 130 contrasts with the white substrate surface 131 and contrasts with a light colored or reflective surface of a trailer when the augmented label 120b is affixed to a wall, ceiling and/or floor of the trailer.

A printed augmented label can also include a unique identifier (e.g., text, a graphic, a barcode, an aruco marker, a logo, or other suitable identifier). For example, augmented labels 120c and 120d are printed augmented labels respectively having text 132 and a barcode 134 as identifiers unique with regard to the interior of the trailer. An augmented label 120 can also be a wireless augmented label (not shown) including a radio frequency identification (RFID) inlay or a near field communication (NFC) circuit. A wireless augmented label can be affixed to a housing of an active RFID tag (e.g., an ultra-wideband (UWB) RFID tag or Bluetooth Low Energy (BLE) tag). A wireless augmented label can facilitate label identification via an RF reader independent of a visual contrast detected by the monitor 102. The unique identifier can be carried in the contrasting image and/or stored in a memory of the wireless augmented label. The unique identifier can carry data including, but not limited to, a label size and/or type, trailer data (e.g., size, color, shape, origin, destination, etc.), loader, AMR, and/or specialized equipment data, and time and/or date data.

Referring back to FIG. 8, as mentioned above, the processor 104 can be in wireless (shown) or wired (not shown) communication with at least one mobile terminal 106 (e.g., a smartphone, tablet, laptop, etc.) within the network for purposes of conveying information via a user interface 114 of the terminal 106 or providing instructions for loading the trailer to a loader using the terminal 106. The user interface 114 can provide an audible alert or a distinct vibration pattern for a worn device, or the user interface 114 can be a graphical display or textual device.

In an embodiment, the terminal 106 can be a mobile imaging device operable to image and/or map the interior of the trailer. The mobile imaging device 106 is also operable to determine a number and/or position of one or more augmented labels 120 within the interior of the trailer. The mobile imaging device 106 can comprise a processor or controller 123, a communications interface 124 (e.g., a transceiver) in wireless (shown) or wired (not shown) communication with the processor 104 and a mobile printing device 122, an image capture module 125, a user interface 114 (e.g., a graphical user interface and/or touchscreen), and inertial tracking circuitry 126.

The mobile imaging device 106 can be associated with a trailer and can capture at least one image from a field of view including an interior portion of the trailer. As shown in FIG. 8, a trailer can have multiple sections (e.g., left and right belly sections 112, a nose section 108, and a main section 110). A portion or an entirety of at least one of these sections (e.g., the left and right belly sections 112 and the nose section 108) may be hidden from a field of view of the monitor 102. For example, a monitor 102 positioned proximate to an entrance of the trailer to capture images of the nose section 108 may be obstructed by a deck (e.g., a floor) of the trailer from capturing images of the left and right belly sections 112 hidden underneath the trailer floor.

As such, the mobile imaging device 106 may capture images of the interior of the trailer so either the mobile imaging device 106 or processor 104 can utilize the captured images and a simultaneous localization and mapping (SLAM) algorithm to generate and/or update a map of the interior of the trailer including sections hidden from the field of view of the monitor 102. For example, a user can move the mobile imaging device 106 to various positions and/or orientations within the trailer to capture images thereof to facilitate the mapping of visible and hidden sections of the interior of the trailer.

The processor 104 can utilize the captured images by the mobile imaging device 106 to determine whether a trailer has a hidden section. For example, the processor 104 can determine a type of trailer from the captured images and at least one attribute (e.g., a hidden belly section) of the trailer based on the determined trailer type. Alternatively, the processor 104 can determine at least one attribute (e.g., wall rib spacing) of the trailer from the captured images and a type of trailer based on the determined attribute as a trailer type having a hidden belly section. The processor 104 can also compare captured images to determine whether a trailer has a hidden section. For example, the processor 104 can determine whether the trailer has a hidden section by comparing images captured by the monitor 102 and the mobile imaging device 106 and/or comparing images captured by the mobile imaging device 106. The processor 104 can also receive a static map of the interior of the trailer. The processor 104 can optimize a correlation of coordinates of the SLAM generated and/or updated map (as described above) and the static map based on at least one of image information associated with the images captured by the mobile imaging device 106 and image information associated with the images captured by the monitor 102.

The mobile imaging device 106 can also detect an augmented label 120 and a position thereof and include the detected position of the augmented label 120 in the generated and/or updated map of the interior of the trailer. The mobile imaging device 106 can also concurrently display a captured image via the user interface 114 and information of an augmented label 120 therein (e.g., via augmented reality (AR)). For example, the mobile imaging device 106 can detect an image of an augmented label 120 within a captured image displayed via the user interface 114 and can highlight (e.g., via a boundary box or color shading) the image of the augmented label 120 in the captured image displayed via the user interface 114. A user can interact with the user interface 114 (e.g., via a user input on a touchscreen) to confirm and/or annotate the augmented label 120. The mobile imaging device 106 can also extract information (e.g., text, barcode data, aruco identifier, etc.) from the highlighted image of the augmented label 120.

The mobile imaging device 106 can also determine whether a trailer and/or respective section thereof lacks visual markers or comprises insufficient visual markers detectable by the monitor 102. For example, if the mobile imaging device 106 does not detect an augmented label 120 within a captured image, then the mobile imaging device 106 can display the captured image via the user interface 114 and highlight (e.g., via a boundary box or color shading) a portion of the captured image corresponding to an interior of the trailer suitable for positioning an augmented label 120. The mobile imaging device 106 can also alert a user via at least one of an audible tone, a message, and a light indicator (e.g., a laser, a light projection or a light-emitting diode (LED)) regarding a suitable position of an augmented label 120 within the interior of the trailer. The mobile imaging device 106 can return to mapping the interior of the trailer when the augmented label 120 is positioned within the interior of the trailer.

In an embodiment, the present invention can also include a mobile printing device 122 (e.g., a mobile printer). The processor 104 and the mobile imaging device 106 can be in wireless (shown) or wired (not shown) communication with the mobile printer 122 within the network to provide instructions to the mobile printer 122 to print and/or encode an augmented label 120. The mobile imaging device 106 can generate and transmit instructions to the mobile printer 122 via a wireless connection (e.g., Bluetooth® or WiFi®) or a wired connection (e.g., a cable). Alternatively, the processor 104 can receive or generate instructions and then transmit the instructions to the mobile printer 122 via a wireless connection (e.g., Bluetooth® or WiFi®) or a wired connection (e.g., a cable). For example, in response to receiving an alert from the mobile imaging device 106 regarding a suitable position of an augmented label 120 within an interior of a trailer, a user can confirm a position of the augmented label 120 via the user interface 114 causing the mobile imaging device 106 to transmit instructions to the mobile printer 122 to print and/or encode the augmented label 120.

The mobile printer 122 can facilitate printing and/or encoding of an augmented label 120 having a unique identifier via printing data selected by the mobile imaging device 106 or the processor 104. In an embodiment, the mobile processor 104 or the mobile imaging device 106 can select data based on a unique identifier type and/or use case including but not limited to, aruco markers associated with the trailer, trailer data (e.g., a size, color, shape, origin, destination, etc.), user data, time and/or date data, trailer mapping data, and serialization data transmit the selected data and formatting instructions to the mobile printer. The mobile printer 122 can format the selected data based on the formatting instructions, generate a printable representation, and print the printable representation onto the label. In another embodiment, a loader can select data and/or a format presented on a user interface 114 of the mobile imaging device 106 or the mobile printer 122. The data selection can be transmitted to a processor (not shown) of the printer 122 which can recall the data and/or formatting instructions from memory, generate a printable representation, and print the printable representation onto a label. For example, the mobile printer 122 can be configured to print a series of aruco codes or serialized barcodes such that, when a first label prints and a sensor detects that the label has been removed by a user, the subsequent label can print automatically. The mobile printer 122 can also select and annotate data to print and/or encode an augmented label 120.

In an embodiment, the present invention can also include at least one mirror 128 to facilitate image capture of a hidden section of a trailer. A trailer may be parked and a door thereof opened such that a field of view of the monitor 102 includes at least a portion of an interior of the trailer. A monitor 102 can be in a fixed position and, given the spatial positioning of the fixed monitor 102 and parked trailer, there may be a hidden section of the interior of the trailer that is outside the field of view of the monitor 102. As the mobile terminal 106 is moved about within the interior of the trailer it may change a pose thereof to provide the capture of images of various sections of the trailer. In some positions, the mobile imaging device 106 may capture images of a section hidden from the field of view of the monitor 102. The mobile imaging device 106 can alert a user to position a mirror 128 within the interior of the trailer when the mobile imaging device 106 or processor 104 detects a hidden section of the trailer. In this way, the mirror 128 can reflect light between the hidden section and the monitor 102 such that the monitor 102 can view and capture images of the interior of the trailer including images of the hidden section. The processor 104 may use the captured images to measure loading efficiency, to map the interior of the trailer, or for other uses.

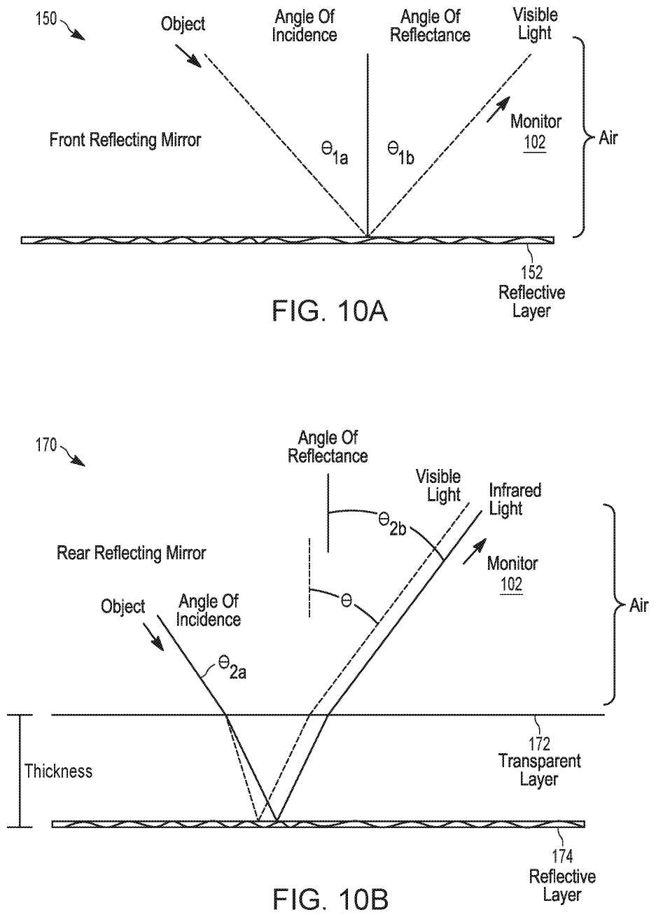

The mirror 128 may be one of several types. As shown in FIGS. 10A and 10B, the mirror 128 can be a front reflecting mirror 150 or a rear reflecting mirror 170. The front reflecting mirror 150 can be comprised of stone or metal (e.g., a polished sheet of aluminum) that can provide a smooth reflecting surface or reflective layer 152. The rear reflecting mirror 170 can comprise a smooth transparent layer 172 (e.g., glass, acrylic, or polycarbonate) coated with a reflective layer 174 (e.g., silver). The mirrors 150, 170 may be flat (as shown) or curved (not shown).

It should be understood that a mirror (e.g., mirror 128) reflects light waves in an equal but opposite direction. As shown in FIG. 10A, light arriving through air at a surface position of a front reflecting mirror 150 at an angle of incidence θ₁ₐ will be reflected at an angle of reflection θ_{1b}, the same as the angle of incidence θ₁ₐ, from the surface position of the front reflecting mirror 150. As shown in FIG. 10B, light arriving through air at a surface position of a rear reflecting mirror 170 at an angle of incidence θ₂ₐ will also be reflected at an angle of reflection θ_{2b} the same as the angle of incidence θ₂ₐ.

For a rear reflecting mirror 170, the light first passes through the transparent layer 172 before reaching the smooth reflective layer 174, reflects from the reflective layer 174, then passes back through the transparent layer 172 and back to air. When light passes from air to the transparent layer 172, the light changes path based on an index of refraction of the transparent layer 172 and changes path again when it passes from the transparent layer 172 back to air such that the angle of reflection θ_{2b} is the same as the angle of incidence θ₂ₐ.

The index of refraction of the transparent layer 172 may vary based on the material of the transparent layer 172 and the wavelength of the reflected light. For example, a transparent layer of window glass has an index of refraction of 1.52, a transparent layer of lucite, acrylic, or Plexiglass has a lower index of refraction of 1.49, and a transparent layer of polycarbonate or Lexan has a higher index of refraction of 1.58. As light wavelength increases, the index of refraction decreases, so the index of refraction of visible light is greater than the index of refraction of infrared light. Accordingly, visible light arriving on a path at a rear reflecting mirror 170 will bend more than infrared light arriving on the same path. As the light reflects from the reflective layer 174, the visible light will be offset from the infrared light, even though both will reflect at the same angle from which they arrived.

In an embodiment, the monitor 102 projects infrared light and captures an image of the infrared light reflected from at least one object present in the interior of the trailer. The monitor 102 may determine a time of flight of the infrared light and thus determine a distance that the light traveled by measuring a phase difference between the projected light and the returned light. The time of flight may be used to calculate a three-dimensional point cloud of the objects that may be used by the processor 104 to determine trailer analytics. The monitor 102 may also capture two-dimensional images from the field of view thereof based on visible light (e.g., sunlight or electric lights) illuminating the trailer and reflected by the objects. The monitor 102 may associate the three-dimensional point cloud with the two-dimensional images since visible light and infrared light traveling on a same path from the object arrive on the same path at the monitor 102.

It should be understood that the arrival paths of visible light and infrared light at the monitor 102 will differ when visible light and infrared light traveling the same path from the object reflect from a rear reflecting mirror 170. The server 104 may account for this difference by adjusting the three-dimensional point cloud and/or captured two-dimensional images based on a thickness of the angle of reflectance θ_{2b}, an index of refraction of the transparent layer 172, and an angle of the rear reflecting mirror 170 (e.g., a reflective angle of the rear reflecting mirror 170 relative to the monitor 102). It should also be understood that infrared light projected from the monitor 102, through air to the rear reflecting mirror 170, through air to a hidden section, reflecting from an object to the rear reflecting mirror 170, and reflecting from the rear reflecting mirror 170 back to the monitor 102, passes through the transparent layer 172 of the rear reflecting mirror 170 more slowly than through air thereby increasing the time of flight measured by the monitor 102. As such, to determine a distance traveled by the infrared light, it may be desirable to adjust the three-dimensional point cloud of the objects to account for a thickness of the transparent layer 172, an index of refraction of the transparent layer 172, the angle of the rear reflecting mirror 170 (e.g., the reflective angle of the rear reflecting mirror 170 relative to the monitor 102).

The processor 104 can process the captured images to detect an augmented label 120 positioned in the hidden section. A portion or an entirety of the augmented label 120 positioned in the hidden section can be printed in reverse such that a printed graphic or combination of graphics (e.g., text, barcode, aruco code or other graphic) appear non-reversed in images captured by the monitor 102. A mirror 128 positioned within the interior of the trailer to facilitate the capture of images by the monitor 102 of a hidden belly section 112 of the trailer can be referred to as a belly mirror.

The mirror 128 can include an augmented mirror label 129. The augmented mirror label 129 can be positioned on the mirror 128 and used by the processor 104 to determine whether the mirror 128 is within the field of view of the monitor 102. For example, the monitor 102 can capture an image and detect the augmented mirror label 129 within the captured image to determine the mirror 128 is positioned within the field of view of the monitor 102. Based on the determination, the processor 104 and/or the mobile imaging device 106 can alert a user to reposition the mirror 128 or to remove the mirror 128 (e.g., when trailer loading or unloading does not require monitoring).

The augmented mirror label 129 can be printed on a clear substrate and affixed to the mirror 128 via an adhesive backing. It should be understood that light passing from the trailer through an unprinted portion of the clear substrate and reflecting from the mirror 128, passing again through the unprinted portion of the clear substrate, and arriving at the monitor 102 can be depicted at a different intensity in a captured image than light arriving from an image printed on the augmented mirror label 129. The printed image can be dark, light or fluorescent to provide a contrasting visible mark detectable by the monitor 102. In an embodiment, the printed non-reflective image reflects less light than the reflective mirror 128 on which it is affixed such that it appears dark in a captured image.

In various embodiments, the augmented mirror label 129 may be within the field of view of the monitor 102 when a front surface of the mirror 128 is within the field of view of the monitor 102 and the augmented mirror label 129 is mounted to a front surface of a front reflecting mirror 150, a front surface of a rear reflecting mirror 170, or a rear surface of a transparent layer 172 of the rear reflecting mirror 170.

In an embodiment, the augmented mirror label 129 may include an identifier (e.g., text 132, a graphic, a barcode 134, an aruco marker, or other suitable identifier) encoding information about the mirror 128. For example, a barcode 134 may encode a mirror type (e.g., a front reflecting mirror 150 or a rear reflecting mirror 172 and/or a manufacturer SKU), a type of transparent layer 172 (e.g., Lucite, glass, polycarbonate, etc.), a thickness of the transparent layer 172, or other information. This information may be decoded from a captured image of the augmented mirror label 129 to determine information for correlating a captured three-dimensional point cloud with a two-dimensional captured image or for adjusting time of flight data as described above.

An augmented mirror label 129 mounted to a surface of a mirror 128 may also include a black square graphic 130. The angles between the edges of the square in a captured image comprising the black square graphic 130 may be used to determine an angle between a surface of the mirror 128 and the monitor 102. For example, an orientation of the surface of the mirror 128 may be determined to be orthogonal to the field of view of the monitor 102 when the captured image comprising the black square graphic 130 appears square. The determined angle between the surface of the mirror 128 and the monitor 102 may also provide for correlating a captured three-dimensional point cloud with a two-dimensional captured image or for adjusting time of flight data as described above.

In an embodiment, the augmented mirror label 129 can include or be one or more of an RFID tag, a printed image (e.g., text, a graphic, a barcode, an aruco marker, etc.) in the transparent layer 172 of a rear reflecting mirror 170, a slot antenna formed in the reflective layer of the mirror 128 coupled with an RFID chip, an active RFID tag with a 3-axis accelerometer sensing orientation, or other types of augmented mirror labels that may be used in a similar way given appropriate sensing capabilities of the system.

It should be understood that the trailer can comprise more than one mirror 128. For example, a plurality of mirrors 128 can be positioned within the interior of the trailer to provide the monitor 102 with views of a plurality of hidden trailer sections (e.g., a shelf section (not shown) and a belly section 112). Each mirror 128 can include an augmented mirror label 129 having a unique identifier and/or wireless functionality to facilitate detection of each mirror 128 by the monitor 102.

Advantageously, the apparatus and method described herein introduces a depth/volume monitor to compute the efficiency incrementally in real-time as the trailer is being loaded. Specifically, the present invention combines package loading information with trailer load monitors to compute a real-time measurement of trailer utilization and accommodating trailers with multiple sections, some of which may not be directly sensed by the trailer monitor. The present invention works whether the trailer monitors provide depth or volume information and still provides useful information in absence of a trailer monitor. The monitors may also be stationary or mobile, as long as the measurements can be referenced to the trailer coordinate system.

Advantageously, the system and method described herein provide for real-time mapping of an interior of a trailer to optimize a measurement of the interior space thereof and to improve an accuracy of metrics (e.g., trailer utilization, efficiency, etc.) associated with loading of the trailer. For example, the system and method provide for one or more of an augmented label, a mobile imaging device, a mobile printing device and a mirror having an augmented mirror label to optimize the measurement of the interior space of the trailer and to improve a performance of a monitor operable to image the interior space of the trailer during loading of the trailer.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A device for facilitating image capture of an interior of a trailer by a monitor comprising:
a reflective surface configured to reflect light between the interior of the trailer and the monitor to modify a field of view of the monitor; and
a label affixed to the reflective surface, the label comprising a non-reflecting indicia indicative of a position of the label in the interior of the trailer,
wherein the monitor has a field of view comprising the reflective surface and the label.

2. The device of claim 1, wherein the reflective surface is a front reflecting mirror comprising stone or metal.

3. The device of claim 1, wherein
the reflective surface is a rear reflecting mirror comprising a transparent layer coated with a reflective layer, the transparent layer being one of glass, acrylic and polycarbonate and the reflective layer comprising metal.

4. The device of claim 1, wherein the label is one of a radio frequency identification (RFID) tag, a printed image being at least one of text, a graphic, a barcode, and an aruco marker, a slot antenna coupled with an RFID chip, and an RFID tag with a 3-axis accelerometer.

5. A system for facilitating image capture of an interior of a trailer comprising:
a monitor configured to capture at least one image of the interior of the trailer;
a reflective surface configured to reflect light between the interior of the trailer and the monitor to modify a field of view of the monitor; and
at least one label comprising an indicia indicative of a position of the at least one label in the interior of the trailer,
wherein the monitor has a field of view comprising at least one of the reflective surface and the at least one label.

6. The system of claim 5, wherein the at least one label is affixed to the reflective surface.

7. The system of claim 5, wherein the at least one label is positionable in the interior of the trailer outside the field of view of the monitor and within the modified field of view of the monitor.

8. The system of claim 5, wherein the monitor is a three-dimensional depth/volume camera operable to transmit time of flight timing light towards the reflective surface for reflection into an interior of the trailer outside the field of view of the monitor and within the modified field of view of the monitor.

9. The system of claim 5, wherein the at least one label is an augmented label having a first surface opposing a second surface, the first surface being coated with an adhesive and the second surface including the indicia.

10. The system of claim 9, wherein the indicia is a printed image comprising at least one of text, a graphic, a barcode, and an aruco marker and is associated with at least one of trailer information and a position of the augmented label in the interior of the trailer

11. A system for mapping a trailer, the system comprising:
a mobile imaging device operable to
capture a first plurality of images of an interior of the trailer, the first plurality of images being indicative of a visible section of the trailer and a hidden section of the trailer,
determine, based on the first plurality of images, a position for at least one label in the hidden section of the trailer, and
alert, based on the determination, a user to affix the at least one label to the determined position;
a mirror positioned within the interior of the trailer;
a monitor operable to capture a second plurality of images, the second plurality of images being indicative of a mirror reflection of the hidden section provided by the mirror; and
a processor coupled to the mobile imaging device and the monitor, the processor operable to generate a map of the interior of the trailer using at least one of first image information associated with the first plurality of images and second image information associated with the second plurality of images.

12. The system of claim 11, wherein the monitor is a three-dimensional depth/volume camera operable to transmit time of flight timing light towards the mirror for reflection into the hidden section.

13. The system of claim 11, wherein the at least one label is an augmented label having a first surface opposing a second surface, the first surface being coated with an adhesive and the second surface including an indicia.

14. The system of claim 13, wherein
the indicia is a printed image comprising at least one of text, a graphic, a barcode, and an aruco marker and is associated with at least one of trailer information and a position of the augmented label in the interior of the trailer, and
the processor is further operable to decode the at least one of the trailer information and the position of the augmented label in the interior of the trailer.

15. The system of claim 11, wherein the processor is further operable to
receive a static map of the interior of the trailer, and
optimize a correlation of coordinates of the map and the static map based on at least one of the first image information associated with the first plurality of images and the second image information associated with the second plurality of images.

16. The system of claim 11, further comprising a printing device, wherein
one of the mobile imaging device and the processor transmit instructions to the printing device to print the label, and
the printing device, in response to receiving the instructions, prints the at least one label.

17. The system of claim 11, wherein a mobile imaging device is operable to alert, based on the determination, the user to affix the at least one label to the determined position by displaying the determined position on a display of the mobile imaging device.
